(19) United States
(12) Patent Application Publication
(10) Pub. No.: US 2004/0000545 A1
(43) Pub. Date: Jan. 1, 2004

(54) Microwave oven, and guide roller, cooking tray and dish for use in microwave oven

(75) Inventor: Sun-Ki Kim, Suwon-City (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD, Suwon-City (KR)

(21) Appl. No.: 10/259,879

(22) Filed: Sep. 30, 2002

(30) Foreign Application Priority Data
Jun. 29, 2002 (KR) 2002-37610

(51) Int. Cl. H05B 6/64

(52) U.S. Cl. 219/754; 219/762

(57) ABSTRACT

A guide roller, and a cooking tray and a dish for use in a microwave oven are provided with a pad which absorbs high-frequency electromagnetic waves, so as to evenly cook food disposed therein or thereon. The microwave oven includes the pad provided in its cooking chamber to absorb the high-frequency electromagnetic waves. The pad may be attached to the guide roller, the cooking tray, the dish for use in the microwave oven, or any combination thereof. Alternatively, the guide roller, the cooking tray, the dish, or any combination thereof may be made of a material which absorbs the high-frequency electromagnetic waves.

### CROSS-REFERENCE TO RELATED APPLICATIONS

This application claims the benefit of Korean Patent Application No. 2002-37610 filed on Jun. 29, 2002, in the Korean Industrial Property Office, the disclosure of which is incorporated herein by reference.

### BACKGROUND OF THE INVENTION

1. Field of the Invention

The present invention relates to a microwave oven, and a guide roller, a cooking tray and a dish for use in the microwave oven. More particularly, the present invention relates to a microwave oven having a guide roller and/or a cooking tray, and a dish for use in the microwave oven, which are provided with a pad that absorbs high-frequency electromagnetic waves so as to evenly cook food disposed therein or thereon.

2. Description of the Related Art

Generally, a microwave oven is an electrically operated oven which cooks food therein by repeatedly exciting molecular bonds of moisture in the food using high-frequency electromagnetic waves. The high-frequency electromagnetic waves generated from a magnetron of the microwave oven generate intermolecular frictional heat within the food. The high-frequency electromagnetic waves are generated from an antenna assembly of the magnetron, which is provided in an electric component compartment of the microwave oven, and are introduced into a cooking chamber through a waveguide of the microwave oven.

FIG. 1 shows an internal structure, i.e., a cooking chamber 101 of a conventional microwave oven described above.

As shown in FIG. 1, the cooking chamber 101 is provided on its side wall with a wave-emitting area 105, which allows the high-frequency electromagnetic waves generated from the antenna assembly (not shown) of the magnetron (not shown) to be introduced into the cooking chamber 101. The cooking chamber 101 is provided on its bottom with a roller guide 102 with rollers 102a, which is adapted to rotate about a driving protrusion 104. The rollers 102a are partially inserted in an annular groove formed on the bottom surface of the cooking chamber 101. A cooking tray 103 is placed on the guide roller 102, and is centrally provided at its lower surface with rotating protrusions (not shown), which engage with the driving protrusion 104. An operation of such a conventional microwave oven will now be described.

To use such a conventional microwave oven, a user places a dish with food placed thereon on the cooking tray 103, and closes a door (not shown) of the microwave oven. Subsequently, the user inputs information, such as a desired cooking condition, and turns the microwave oven on. At this point, high-frequency electromagnetic waves generated from the magnetron are introduced into the cooking chamber 101. The driving protrusion 104 provided on the bottom of the microwave oven is then rotated to achieve even cooking of the food, and the cooking tray 103 is supplied with a rotating force of the driving protrusion 104 where the rotating protrusions of the cooking tray 103 engage with the driving protrusion 104.

The microwave oven is provided with the guide roller 102 with the rollers 102a, between its bottom panel and the cooking tray 103, to reduce a frictional force of the bottom panel and obtain a balanced posture of the cooking tray 103. Accordingly, the cooking tray 103 is smoothly rotated about the driving protrusion 104. At this point, since the rollers 102a provided at the guide roller 102 are partially inserted in the annular roller groove formed on the bottom panel of the microwave oven, the guide roller 102 is only rotated in place while maintaining its horizontal position. Therefore, the food placed on the cooking tray 103 is rotated at a certain angular velocity, thereby allowing the food to be evenly cooked.

It is believed that the electromagnetic waves exhibit complete reflection for conductors, and complete transmission for articles such as glass products.

Since the guide rollers 102 and the cooking trays 103 of the conventional microwave oven are made of, for example, glass, and are only used to rotate the food placed thereon without considering an absorption degree for the electromagnetic waves, the food is not evenly cooked.

### SUMMARY OF THE INVENTION

Accordingly, it is an object of the present invention to provide a microwave oven having a guide roller and/or a cooking tray, and a dish for use in the microwave oven, which are capable of allowing food disposed thereon to be evenly cooked.

Additional objects and advantages of the invention will be set forth in part in the description which follows and, in part, will be obvious from the description, or may be learned by practice of the invention.

To achieve the above and other objects of the present invention, there is provided a microwave oven comprising a cooking chamber, and an absorbing pad which is provided in the cooking chamber and absorbs high-frequency electromagnetic waves.

The absorbing pad may be attached to a guide roller and/or a cooking tray of the microwave oven, or a dish for use in the microwave oven. Alternatively, the guide roller and/or the cooking tray, or the dish for use in the microwave oven may be made of a material which absorbs the high-frequency electromagnetic waves. Accordingly, the present microwave oven allows an improved even cooking of the food.

### BRIEF DESCRIPTION OF THE DRAWINGS

These and other objects and advantages of the present invention will become apparent and more readily appreciated from the following description of the embodiments, taken in conjunction with the accompanying drawings of which:

FIG. 1 is a front view illustrating an internal structure of a cooking chamber of a conventional microwave oven;

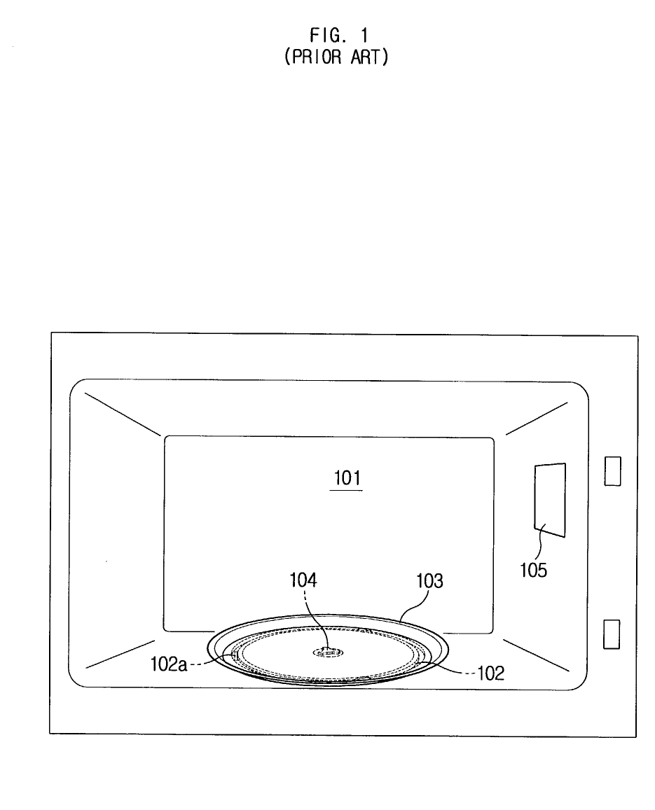

FIG. 2 is an exploded perspective view of components installed in a microwave oven according to an embodiment of the present invention;

FIG. 3 is a top plan view of a guide roller of the present invention having a pad which absorbs high-frequency electromagnetic waves;

FIG. 4 a plan view of a cooking tray of the present invention having a mashed potato placed thereon, and on which a coordinate is plotted to show experimental results of the present invention; and

FIG. 5 is a perspective view of a cooking tray having a pad which absorbs the high-frequency electromagnetic waves according to another embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below in order to explain the present invention by referring to the figures.

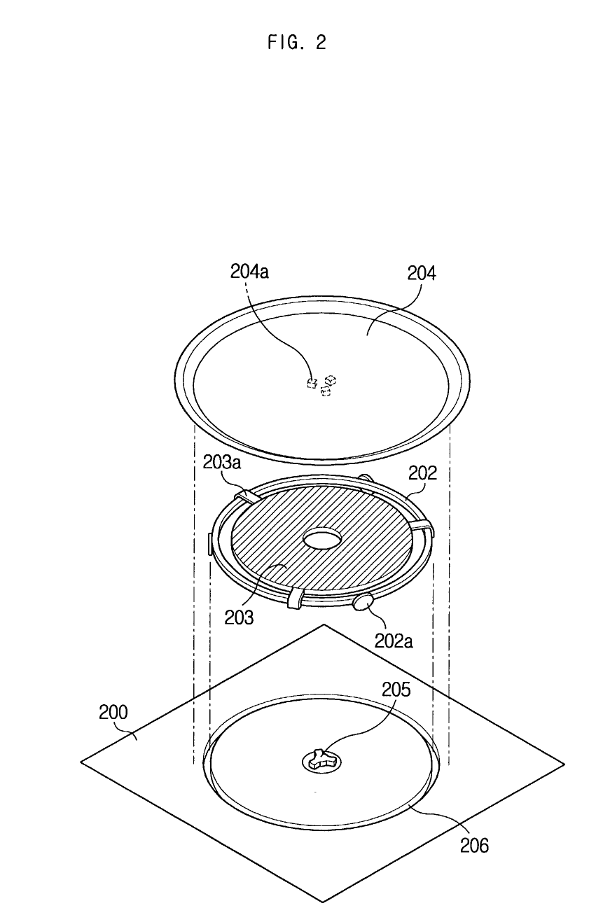

FIG. 2 shows an exploded perspective view of components provided in a microwave oven according to an embodiment of the present invention. As shown in FIG. 2, the microwave oven is centrally provided at its bottom panel 200 with a driving protrusion 205 which supplies a force required to rotate food during a cooking operation. The bottom panel 200 is further formed with an annular roller groove 206 having a certain radius relative to the driving protrusion 205. The annular roller groove 206 partially receives rollers 202a provided at a periphery of a guide roller 202, such that the guide roller 202 is stably rotated about its radial displacement. The guide roller 202 is centrally perforated to form a through hole. A circular pad, i.e., an absorption pad 203 is detachably attached to an upper surface of the guide roller 202 by its holding pieces 203a, and absorbs high-frequency electromagnetic waves. The absorption pad 203 can be selectively detached from the guide roller 202 if required. A cooking tray 204 is placed on the guide roller 202, and allows food (not shown) or a dish with the food to be placed thereon. The cooking tray 204 is provided at its lower surface with rotating protrusions 204a, which engage with the driving protrusion 205 of the bottom panel 200 to receive the rotating force of the driving protrusion 205.

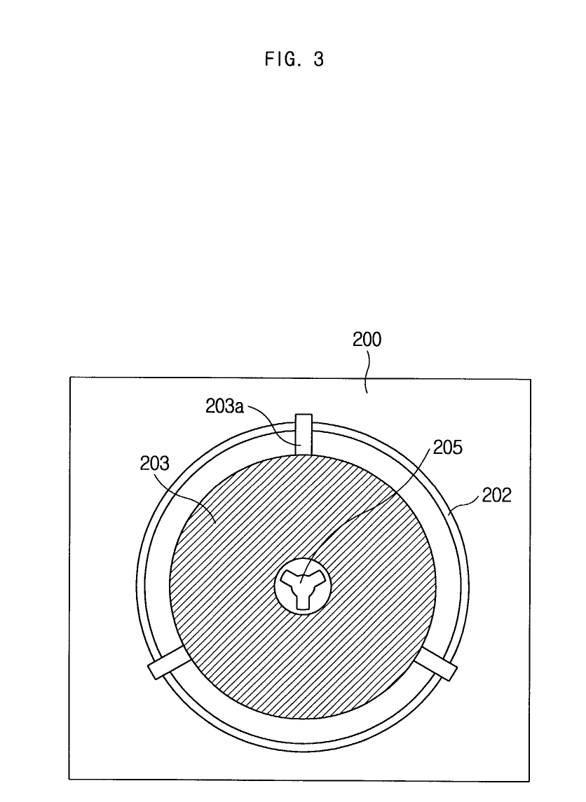

FIG. 3 shows a plan view of the bottom panel of the microwave oven, in which the cooking tray 204 is removed to clearly display the absorption pad 203. The absorption pad 203 is detachably attached to the guide roller 202 by holding pieces 203a. Although the holding pieces 203a are shown as hooks for simplicity of the structure, it is understood that they may be embodied by other holding structures.

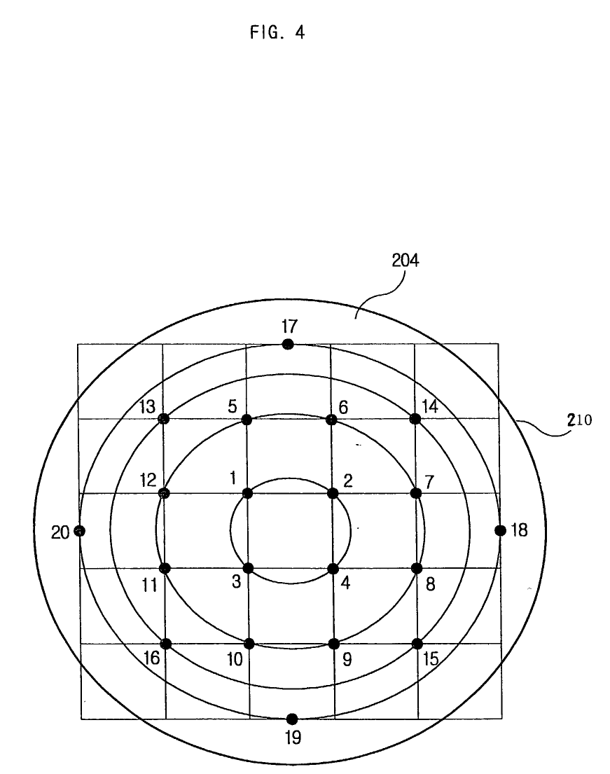

FIG. 4 shows the cooking tray 204 having a mashed potato 210 placed thereon, and on which a coordinate is plotted to show experimental results of the present invention.

For experimental purposes, the mashed potato 210 (a mixture of a crushed potato, butter, oil, water, etc.,) is evenly spread on the cooking tray 204 at a thickness of 4 cm. The mashed potato 210 is first cooked under output electric power of 1174.9 W, an electric current of 17.76 A and for an operating period of about 10 minutes, without attaching the absorption pad 203 to the guide roller 202. In the drawing, black dots positioned on circles, and numerals corresponding to the black dots, designate positions at which respective temperatures of the cooked mashed potato 210 are measured. The temperatures at the corresponding dots are represented in Fahrenheit. The experimental results are shown in the Table 1.

TABLE 1

| No. | Temperature(F.) |
|---|---|
| 1 | 166.10 |
| 2 | 173.84 |
| 3 | 152.24 |
| 4 | 165.74 |
| 5 | 161.60 |
| 6 | 166.46 |
| 7 | 168.62 |
| 8 | 163.22 |
| 9 | 150.80 |
| 10 | 145.76 |
| 11 | 147.20 |
| 12 | 149.18 |
| 13 | 179.42 |
| 14 | 177.26 |
| 15 | 174.92 |
| 16 | 172.94 |
| 17 | 184.46 |
| 18 | 183.38 |
| 19 | 183.92 |
| 20 | 181.94 |

As shown in the Table 1, the temperatures of the mashed potato 210 in areas corresponding to the dots 5 to 12 exhibit relatively lower values than that of areas corresponding to the dots 17 to 20. The standard deviation between the temperatures measured at the dots is calculated to be relatively high at 12.9° F. In other words, without attaching the absorption pad 203 to, for example, the guide roller 202, regions of the mashed potato 210 corresponding to the dots 17 to 20 are relatively quickly cooked while regions of the mashed potato 210 corresponding to the dots 5 to 12 are relatively slowly cooked. This means that there are insufficiently cooked regions and excessively cooked regions after elapse of a desired cooking time.

For comparison, the mashed potato 210 is spread and cooked under the same conditions as those of the above experiment except that the absorption pad 203 is attached to the guide roller 202. The absorption pads 203 may be made by molding a composition which has excellent properties in thermal resistance. That is, materials including polypropylene, polyphenylene sulfide, TEFLON (polytetrafluoroethylene), polysulfone, etc., can be used as an absorption pad 203 to absorb the high-frequency electromagnetic waves. It is believed that the high-frequency electromagnetic waves exhibit absorption for compositions such as the ferrite, polypropylene, polyphenylene sulfide, TEFLON (polytetrafluoroethylene) and polysulfone. Of the above, ferrite is known to have the best absorption effect. In this experiment, the absorption pad 203 made of polypropylene is used. The results of the comparison experiment are shown in the Table 2.

TABLE 2

| No. | Temperature(F.) |
|---|---|
| 1 | 182.12 |
| 2 | 180.86 |
| 3 | 170.24 |
| 4 | 178.70 |
| 5 | 167.00 |
| 6 | 169.16 |
| 7 | 160.52 |
| 8 | 166.28 |
| 9 | 171.14 |
| 10 | 166.28 |
| 11 | 164.12 |
| 12 | 167.36 |
| 13 | 175.82 |
| 14 | 176.90 |
| 15 | 183.56 |
| 16 | 180.50 |
| 17 | 185.18 |
| 18 | 185.18 |
| 19 | 186.62 |
| 20 | 186.26 |

As shown in the Table 2, temperatures of the mashed potato 210 in areas corresponding to the dots 5 to 12 exhibit relatively lower values than that of areas corresponding to the dots 17 to 20, as in the case without the absorption pad 203. However, in the instant case, temperatures measured at the respective dots of the mashed potato 210 are higher at almost all regions. This means that a time period required to cook food can be shortened where the absorption pad 203 is used/attached to the guide roller 202. In addition, the standard deviation between the temperatures measured at all the dots is calculated to be 8.4° F., which is considerably lower than the standard deviation of 12.9° F. obtained without the use of the absorption pad 203. Therefore, the experiments show that the food is more evenly cooked with the use of the absorption pad 203.

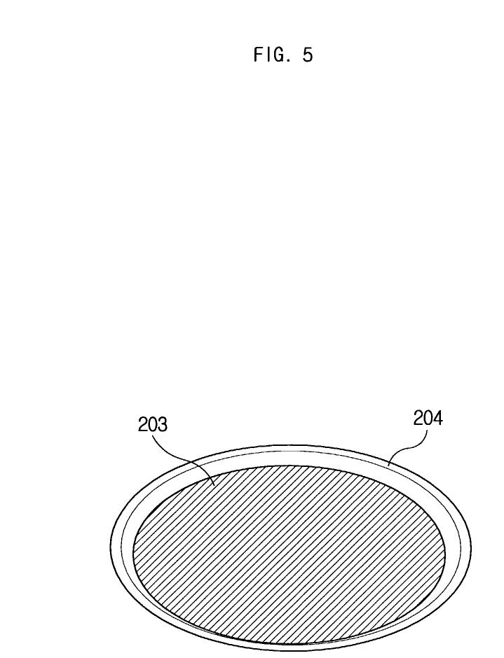

FIG. 5 shows a cooking tray 204 with an absorption pad 203 attached thereto according to another embodiment of the present invention. While the absorption pad 203 is attached to an upper surface of the cooking tray 204, it is understood that the term “attached” is to be broadly construed to include cases where the absorption pad 203 is provided at the upper surface or a lower surface of the cooking tray 204, within the cooking tray 204, or any combination thereof. The cooking tray 104 may also be wholly made of an absorption material which absorbs the high-frequency electromagnetic waves. Alternatively, the absorption pad 203 may also be attached to a dish (not shown) to be placed on the cooking tray 204 to evenly cook food placed therein/thereon. Again, the absorption pad 203 may be provided at an upper surface of the dish, a lower surface of the dish, within the dish, or any combination thereof. On the other hand, the dish itself may be made of the absorption material to absorb the high-frequency electromagnetic waves.

As described above, the present invention provides a microwave oven having a pad which absorbs high-frequency electromagnetic waves attached to a guide roller and/or a cooking tray of the microwave oven, and/or to a dish for use in the microwave oven, so as to evenly cook food. With the present microwave oven, a time period required to cook the food can be reduced as compared to a conventional microwave oven using the same electric power. Accordingly, an amount of electric energy require to cook the food is reduced. Furthermore, it is possible to prevent warping of a container due to temperature differences by overheating during or after an operation of the microwave oven.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A microwave oven comprising:
a microwave generator to generate microwaves;
a cooking chamber into which the generated microwaves are introduced; and
an absorbing pad which is provided in the cooking chamber and absorbs high-frequency electromagnetic waves including the generated microwaves.

2. The microwave oven as set forth in claim 1, wherein the absorbing pad is provided at a lower portion of the cooking chamber.

3. The microwave oven as set forth in claim 2, further comprising a guide roller which is provided in the lower portion of the cooking chamber and guides a rotation of food disposed thereover, wherein the absorbing pad is attached to the guide roller.

4. The microwave oven as set forth in claim 1, further comprising:
a cooking tray provided in a lower portion of the cooking chamber, wherein the absorbing pad is attached to the cooking tray; and
a guide roller which is placed below the cooking tray and guides a rotation of the cooking tray.

5. The microwave oven as set forth in claim 1, further comprising a cooking tray which is provided in a lower portion of the cooking chamber and seats food thereon, wherein the absorbing pad is attached to the cooking tray.

6. A microwave oven comprising:
a microwave generator to generate microwaves;
a cooking chamber; and
a cooking tray which is provided in the cooking chamber and seats food thereon, wherein the cooking tray is made of a material which absorbs high-frequency electromagnetic waves including the generated microwaves.

7. A microwave oven comprising:
a microwave generator to generate microwaves;
a cooking chamber;
a cooking tray which is provided in a lower portion of the cooking chamber and seats food thereon, wherein the cooking tray is made of a material which absorbs high-frequency electromagnetic waves including the generated microwaves; and
a guide roller which is placed below the cooking tray and guides rotation of the cooking tray.

8. A guide roller for use in a microwave oven, comprising an absorbing pad attached to the guide roller, wherein:
the absorbing pad absorbs high-frequency electromagnetic waves, and
the guide roller guides a rotation of food disposed thereover.

9. The guide roller as set forth in claim 8, wherein the absorbing pad is detachably attached to the guide roller.

10. A cooking tray for use in a microwave oven, comprising an absorbing pad attached to the cooking tray, wherein:
the absorbing pad absorbs high-frequency electromagnetic waves, and
the cooking tray seats food thereon.

11. A cooking tray for use in a microwave oven, wherein the cooking tray seats food thereon, and is made of a material which absorbs high-frequency electromagnetic waves.

12. A dish to be placed on a cooking tray of a microwave oven, comprising an absorbing pad attached to the dish, wherein:
the absorbing pad absorbs high-frequency electromagnetic waves, and
the cooking tray seats food thereon.

13. A dish to be placed on a cooking tray of a microwave oven, wherein:
the dish is made of a material which absorbs high-frequency electromagnetic waves, and
the cooking tray seats food thereon.

14. The microwave oven as set forth in claim 1, wherein the absorption pad is made of a material selected from a group consisting of ferrite, polypropylene, polyphenylene sulfide, polytetrafluoroethylene and polysulfone.

15. The microwave oven as set forth in claim 6, wherein the material is selected from a group consisting of ferrite, polypropylene, polyphenylene sulfide, polytetrafluoroethylene and polysulfone.

16. The microwave oven as set forth in claim 1, wherein the absorbing pad is detachably provided to the cooking chamber.

17. The guide roller as set forth in claim 8, wherein the absorption pad is made of a material selected from a group consisting of ferrite, polypropylene, polyphenylene sulfide, polytetrafluoroethylene and polysulfone.

18. The cooking tray as set forth in claim 10, wherein the absorption pad is made of a material selected from a group consisting of ferrite, polypropylene, polyphenylene sulfide, polytetrafluoroethylene and polysulfone.

19. The dish as set forth in claim 12, wherein the absorption pad is a material selected from a group consisting of ferrite, polypropylene, polyphenylene sulfide, polytetrafluoroethylene and polysulfone.

20. The microwave oven as set forth in claim 7, wherein the material is selected from a group consisting of ferrite, polypropylene, polyphenylene sulfide, polytetrafluoroethylene and polysulfone.

21. The cooking tray as set forth in claim 11, wherein the material is selected from a group consisting of ferrite, polypropylene, polyphenylene sulfide, polytetrafluoroethylene and polysulfone.

22. The dish as set forth in claim 13, wherein the material is selected from a group consisting of ferrite, polypropylene, polyphenylene sulfide, polytetrafluoroethylene and polysulfone.

23. The microwave oven as set forth in claim 1, further comprising:
a driving protrusion which is provided in a lower portion of the cooking chamber and supplies a rotating force; and
a cooking tray having a rotating protrusion which engages with the driving protrusion, wherein the cooking tray rotates in response to the rotating force of the driving protrusion.

24. The microwave oven as set forth in claim 23, wherein the absorbing pad is detachably attached to the cooking tray.

25. The microwave oven as set forth in claim 23, further comprising:
an annular groove formed on the lower portion of the cooking chamber, wherein the annular groove has a predetermined radius relative to the driving protrusion; and
a guide roller which is placed below the cooking tray and guides a rotation of the cooking tray, wherein:
the guide roller include rollers which are provided at a periphery of the guide roller, and
the annular groove partially receives the rollers so as to have the guide roller rotate about the predetermined radius.

26. The microwave oven as set forth in claim 25, wherein the absorbing pad is detachably attached to the guide roller.

27. The microwave oven as set forth in claim 1, wherein the absorbing pad evenly cooks food.

28. The microwave oven as set forth in claim 6, wherein the cooking tray evenly cooks the food.
